(19) United States
(12) Patent Application Publication
(10) Pub. No.: US 2005/0137833 A1
(43) Pub. Date: Jun. 23, 2005

(54) Automatic sensor integration

(76) Inventor: Rajasekhar Sistla, Hillsboro, OR (US)

Correspondence Address: FISH & RICHARDSON, PC, 12390 EL CAMINO REAL, SAN DIEGO, CA, 92130-2081, US

(21) Appl. No.: 10/740,882

(22) Filed: Dec. 18, 2003

(51) Int. Cl. G06F 15/00; G06F 11/00; G05B 15/00

(52) U.S. Cl. 702/188

(57) ABSTRACT

A system and a method for dynamically introducing new sensors and new sensor types in a management system includes receiving a descriptor files associated with new sensors and new sensor types and, adding a sensor entry based on the sensor file to the sensor registry and recognizing new sensor types for monitoring.

### BACKGROUND

Management systems provide a common interface to “intelligent” hardware used to monitor characteristics of another system. For example, a management system can monitor characteristics such as temperature, voltage, fan speed, and power supplies in a server. The Intelligent Platform Management Interface (IPMI) protocol is currently the industry standard for managing system components, e.g. the IPMI version 1.5 standard developed jointly by Intel, Hewlett Packard and NEC. IPMI provides autonomous monitoring and recovery based on events associated with sensors. IPMI functionality is provided in a microcontroller that is separate from the main system processors such that the management/monitoring functionality does not depend on the main system processors. The IPMI standard describes both hardware and software processes and can be further configured to provide general management functions such as: automatic alerting, automatic shutdown, restart, and power control.

The Intel NetStructure Chassis Management Module (also referred to as a Shelf Manager) provides centralized out of band management and can reduce MTTR (Mean Time to Repair) in high-density server chassis. Such chassis, intended for carrier grade telecommunications markets consist of many components like SBC (Single Board Computer) boards, fan trays, power supplies etc. The CMM utilizes the IPMI protocol for managing the components in the chassis. In IPMI, a managed component implements sensors to describe the features that are managed and monitored. The IPMI 1.5 specification currently recognizes forty sensor types. Many times a feature that needs to be managed cannot be described by these predefined sensor types. In such cases, the IPMI specification allows the vendor to create OEM sensor types (range is 0xC0-0xFF) that are specific to the vendor implementation.

### DESCRIPTION OF DRAWINGS

FIG. 1 is a block diagram depicting a management system and a set of sensors.

FIG. 2 is a block diagram depicting the integration of new user-defined sensor types into the system.

FIG. 3 is a flow chart of a process for adding new user-defined sensor types.

FIG. 4 is a block diagram depicting the addition of new sensors based upon the user-defined sensor types.

FIG. 5 is a flow chart of a process for adding a new sensor to the management system.

### DESCRIPTION

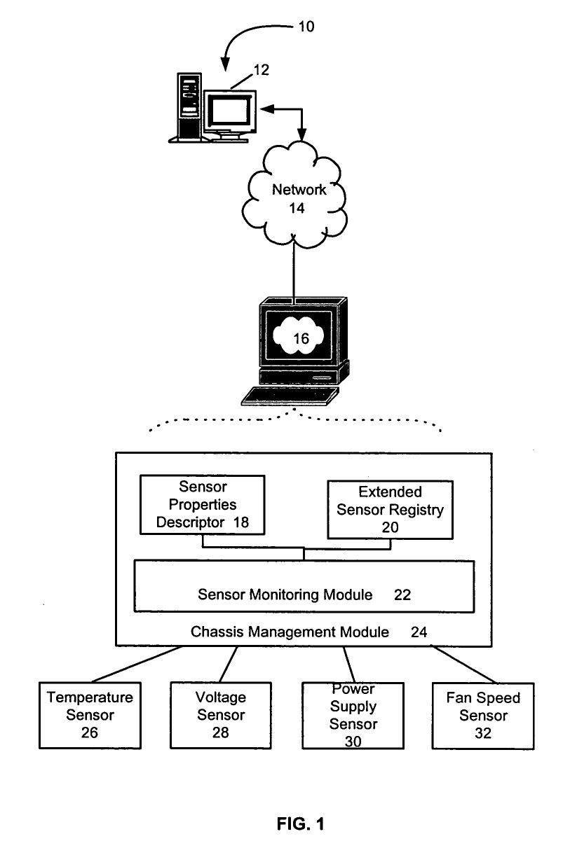

Referring to FIG. 1, a system 10 for monitoring and managing components in a system (e.g., server 16) includes an operator client system 12 in communication with server 16 over network 14. Server 16 includes a chassis management module (CMM) 24 that uses the intelligent peripheral management interface (IPMI) protocol for managing components in the server 16. In IPMI, a component includes sensors that describe a feature managed and monitored by the CMM 24. For example, server 16 includes a hot pluggable board having a temperature sensor 26, voltage sensor 28, power supply sensor 30, and fan speed sensor 32. These sensors can be part of the server 16 when the board is inserted in the system. Chassis management module (CMM) 24 monitors the sensors included in server 16. For the CMM 24 to manage multiple sensors that are added dynamically (e.g., by hot insertion of components), a description of the properties of each dynamic sensor is stored in a separate sensor properties descriptor (SPD) file 18.. The SPD file 18 includes information describing each sensor (e.g., sensors 26, 28, 30, 32) such as name of the sensor (e.g. “CPU temperature”), Sensor Properties as described by the IPMI specification (e.g. sensor nature (threshold based or discrete), the operating thresholds (if applicable), the units for measurement etc), the method to access the sensor to query the status of the sensor etc. An extended sensor registry 20 includes each user-defined sensor monitored by CMM 24. The user-defined sensors are added to the sensor registry 20 using a SPD files. Using the SPD files 18 and the extended sensor registry 20, a sensor monitoring module 22 running on CMM 24 deciphers both the predefined system sensors and the dynamically introduced user-defined sensors, and their capabilities. By decoding event messages generated by the sensors, the sensor monitoring module 22 produces appropriate signals to alert an operator of a failure in one or more of the sensors.

While in the example above, the system 10 includes an operator client system 12 in communication with server 16 over network 14, the CMM 24 may communicate with another content management system, a CPU, or other processor in the system instead of the operator client system 12. In each example, the monitoring occurs at the CMM 24 independent from the main processor of a system 16. This reduces the load of a main processor by only alerting a failure from one of the sensors 26, 28, 30, or 32 to the main processor.

In order to add new sensors and sensor types to a CMM, the operator generates SPD and Sensor Type Descriptor (STD) files respectively. As mentioned above, the SPD files describe the newly added sensor properties.

An STD file is used to add a new sensor type to the CMM 24. In an IPMI standard based system, an STD file includes information describing the number of the sensor (typical range is 0xC0-0xFF), sensor type (e.g., fiber channel status), an indication if the sensor is threshold based or discreet, the units (e.g., Amperes, Volts) for measuring values for a threshold based sensor, and the sensor specific event offsets describing state transitions of discreet sensors. For example, an STD file for voltage sensor 28 includes the sensor number 0xE4, sensor type of threshold, and a measurement unit of Volts.

SPD files are used to add new sensors to the CMM 24. The SPD file includes sensor name, sensor type code, sensor properties, and a method to access the sensor. The SPD file also includes the sensor type. A typical range for sensor types is 0xC0-0xFF. The STD file includes the sensor properties as described by the IPMI sensor data record (SDR).

For example, the sensor properties include sensor nature of threshold or discrete, the operating thresholds, units for measurement, etc. The method to access the sensor included in the SPD file describes how to access the sensor to query the sensor's status. For example, the description can include the socket parameters to connect to the sensor over the network to retrieve the status of a load balancing software executing on a computation board.

A typical IPMI system (e.g., IPMI rev. 1.5) defines sensors statically. In a static system, the CMM does not dynamically recognize and manage software and hardware components added to the system by the end user (e.g. a telecom administrator in the field). For example, in a static system if the end user desires to monitor the load balancing software on the server or an additional temperature sensor, the end user would develop specialized software for this specific purpose. To overcome these limitations system 10 provides a mechanism to dynamically add sensors (e.g., using SPD and STD files) into the chassis management module 24. The ability to dynamically add sensors gives the end user greater flexibility to manage and monitor various components and the components managed by the system are not limited to a predefined number or predefined types of elements.

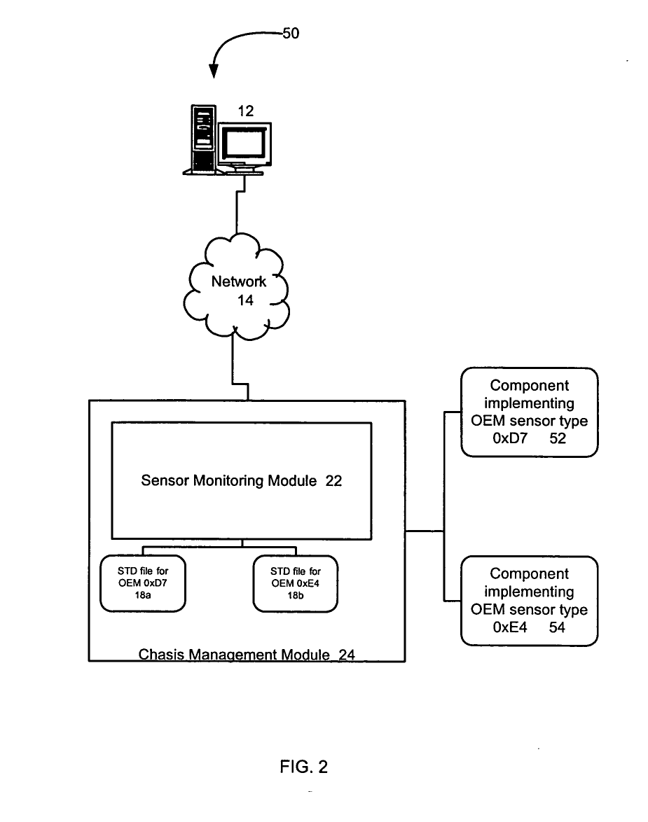

Referring to FIG. 2, a system 50 includes an operator system client system 12 in communication with a chassis management module 24 over network 14. In this example, an operator desires to add a new sensor type to the monitoring system. The chassis management module includes STD files (e.g., 18a and 18b) for each new sensor type. The CMM includes a sensor monitoring module 22 that includes descriptions for recognized OEM sensor components and descriptions of sensor types added by the user.

For example, the CMM 24 can provide centralized out of band management and reduce MTTR (Mean Time to Repair). Such chassis can include many components and utilize the IPMI protocol for managing the components. In IPMI, a component implements sensors to describe a feature that can be managed and monitored. IPMI 1.5 specification currently recognizes forty sensor types. However, a feature that needs to be managed is not always described by these predefined sensor types. In such cases, the IPMI specification allows the vendor to create OEM sensor types (range is 0xC0-0xFF) that are specific to the vendor implementation. The CMM 24 dynamically recognizes the new OEM sensor types and allows different vendors' components to be integrated onto a single system.

In order to monitor the new sensor 56, the CMM 24 dynamically recognizes the addition of a new sensor. In order to monitor new sensor, the CMM 22 deciphers the different IPMI defined sensor types, reads the OEM sensor registry, recognizes OEM sensors, and decodes event messages sent using the IPMI protocol. In order to make the CMM 24 recognize an OEM sensor type, the operator describes the sensor type information in an STD file and copies the STD file to the CMM's file system. Upon instruction, the CMM 24 absorbs the information in the new STD file 60. Subsequently, the CMM monitors the new sensor in addition to the existing sensors.

In this example, a user adds two new sensor types as described by the STD files 18a and 18b. STD file 18a is a file describing component 52. This component describes an OEM sensor type of value 0xD7. Similarly, STD file 18b describes component 54, of OEM sensor type 0xE4.

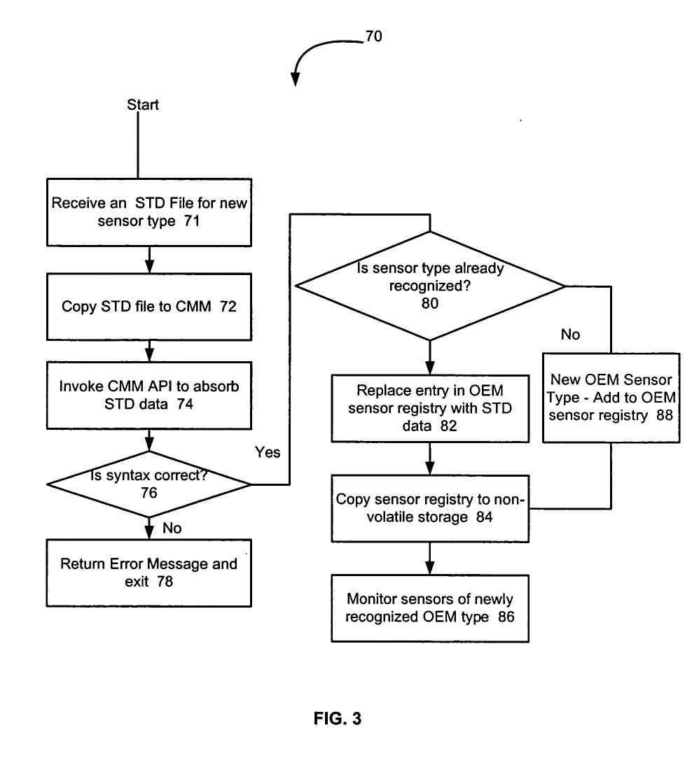

Referring to FIG. 3, a process 70 for integrating a new OEM sensor type is shown. Process 70 includes receiving 71 an STD file from a user for a new sensor type and copying 72 the file to the CMM 24. Process 70 invokes the CMM 24 to adsorb 74 the data in the STD file. Process 70 checks 76 the STD file for the correct syntax. If the syntax is not correct, process 70 returns 78 an error message and exits the process. If the syntax of the STD file is correct, process 70 determines 80 if the sensor type is already recognized. If the sensor type is not recognized, process 70 adds 88 the new OEM sensor type to the OEM sensor registry. If the sensor type is recognized by the CMM 24, process 70 replaces 82 the entry in the OEM sensor registry with the OEM data in the STD file. Subsequent to adding 88 new data or replacing 82 data in the OEM sensor registry, process 70 copies 84 the sensor registry to non-volatile storage (e.g., a hard-drive). Process 70 monitors 86 the newly recognized sensor types.

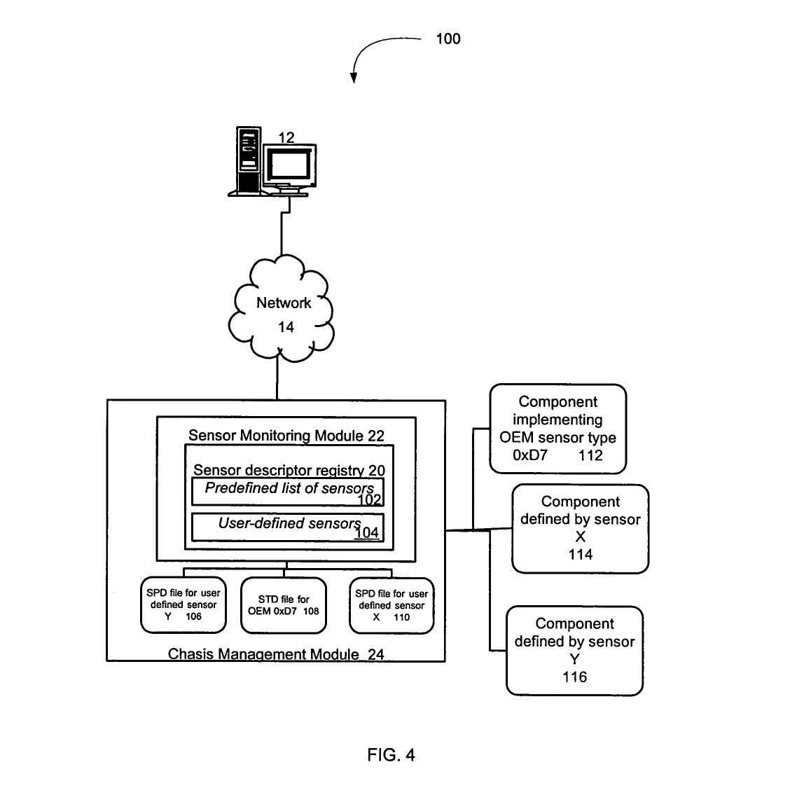

Referring to FIG. 4, a system 100 includes a computer an operator system client system 12 in communication with a chassis management module 24 over network 14. In this example, an operator desires to add a new sensor to be monitored by the CMM 24. The CMM dynamically comprehends and manages the software and hardware components added to the chassis by the end user. For example, an end user may desire to monitor the status of the network load balancing software in the chassis. The CMM 24 provides a mechanism to dynamically add a sensor into the CMM 24 and as a result gives the end user the ability to monitor/manage the elements (software & hardware) in addition to the sensors statically defined in the CMM 24.

For example, a user might desire to add new sensors (e.g., sensors 114 and 116) to be monitored by the CMM 24. In this example, sensors 114 and 116 are sensors of a previously defined type. To monitor these sensors, an SPD file is generated and used by the CMM 24. For example, SPD file 106 describes the sensor 116 and SPD file 110 describes the sensor 114.

In addition, a user might desire to monitor a new component with a sensor type that is not currently defined. To monitor a sensor with an OEM sensor type that is not defined, a user generates a STD file (as described above) and an SPD file. The STD file in combination with the SPD file is used to enable CMM 24 to monitor the new component.

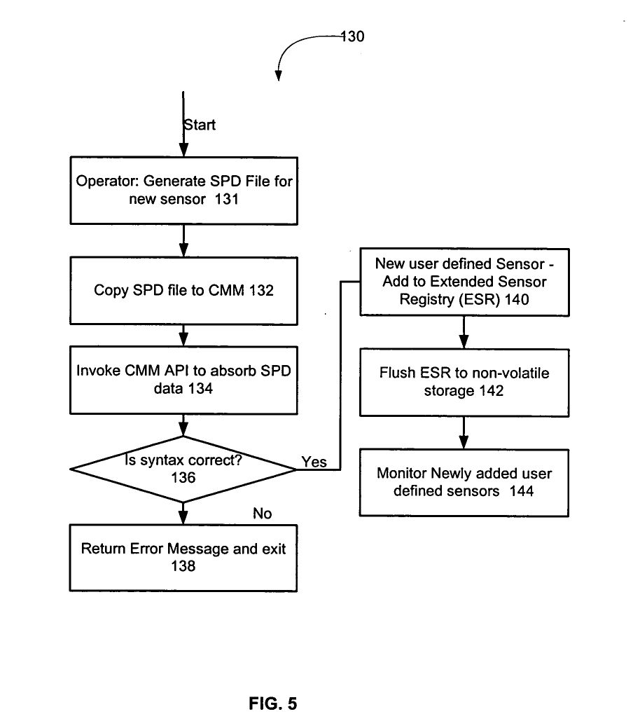

Referring to FIG. 5, a process 130 for integrating a new sensor into the CMM 24 is shown. Process 130 includes generating 131 an SPD file for a new sensor and copying 132 the file for the new sensor to the CMM 24. Process 130 invokes 134 the CMM to adsorb the SPD data from the SPD file. Process 130 determines 136 if the syntax of the SPD file is correct. If the syntax is not correct, process 130 returns 138 an error message and exits the process. If the syntax of the SPD file is correct, process 130 adds 140 the new user defined sensor to the extended sensor registry. Process 130 copies 142 the extended sensor registry to non-volatile storage and monitors 144 the newly added user defined sensors.

The process and system described herein can be implemented in digital electronic circuitry, in computer hardware, firmware, software, or in combinations of them. The process and system described herein can be implemented as a computer program product, i.e., a computer program tangibly embodied in an information carrier, e.g., in a machine-readable storage device or in a propagated signal, for execution by, or to control the operation of, data processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Particular embodiments have been described, however other embodiments are within the scope of the following claims.

1. A method comprising:
dynamically introducing and recognizing new sensors in a management system;
receiving a sensor properties descriptor file associated with a new sensor, the sensor properties descriptor file including a sensor type; and
adding a sensor entry based on the sensor file to the sensor registry.

2. The method of claim 1 further comprising monitoring sensors in the sensor registry.

3. The method of claim 1 further comprising
moving the sensor registry to a non-volatile memory after replacing or adding a new sensor to the sensor registry.

4. The method of claim 1 further comprising
checking the syntax of the sensor properties descriptor file; and
returning an error if the syntax is not correct.

5. The method of claim 1 wherein the new sensor monitors a hardware component.

6. The method of claim 1 wherein the new sensor monitors a software component.

7. The method of claim 1 wherein the sensor properties descriptor file includes a sensor name, sensor type, sensor properties, and access method associated with the new sensor.

8. The method of claim 1 wherein receiving the sensor properties descriptor file includes receiving the sensor file from the new component based on a request from the management system during initialization.

9. A method comprising:
dynamically introducing and recognizing new sensor types in a management system;
receiving a sensor type descriptor file associated with a new sensor type, the sensor type descriptor file including a sensor type;
adding a sensor entry based on the sensor type descriptor file to the sensor registry; and
adding the newly introduced sensor type to the list of recognized and monitored sensor types.

10. The method of claim 9 further comprising checking if the sensor type is included in a sensor registry.

11. The method of claim 10 further comprising replacing a sensor entry in the sensor registry if the sensor type is included in the sensor registry.

12. The method of claim 10 further comprising
checking the syntax of the sensor type descriptor file and
returning an error if the syntax is not correct.

13. The method of claim 10 wherein the new sensor type monitors a hardware component.

14. The method of claim 10 wherein the new sensor type monitors a software component.

15. The method of claim 10 wherein the sensor type descriptor file includes a sensor name, sensor type, sensor properties, and access method associated with the new sensor.

16. A method comprising:
providing sensor registry in a chassis management module;
monitoring a set of sensors included in the sensor registry;
dynamically updating the sensor registry to include a new sensor in response to client input; and
monitoring the new sensor in addition to the set of sensors.

17. The method of claim 16 further comprising
receiving a sensor type descriptor file from a client associated with the new sensor and monitoring the new sensor using the properties in the sensor type descriptor file.

18. A computer program product, tangibly embodied in an information carrier, for executing instructions on a processor, the computer program product being operable to cause a machine to:
dynamically introduce and recognize new sensors and new sensor types in a management system;
receive a sensor file associated with a new sensor, the sensor file including a sensor type;
add a sensor entry based on the sensor file to the sensor registry; and
add the newly introduced sensor type to the list of recognized and monitored sensor types.

19. The computer program product of claim 18 further comprising instructions causing a machine to monitor sensors in the sensor registry.

20. The computer program product of claim 18 further comprising instructions causing a machine to check if the sensor type is included in a sensor registry.

21. The computer program product of claim 18 further comprising instructions causing a machine to:
check the syntax of the sensor file; and
return an error if the syntax is not correct.

22. A system comprising:
a server;
a sensor; and
a sensor management system, the sensor management system configured to:
dynamically introduce and recognize new sensors and new sensor types in the management system;
receive a sensor file associated with a new sensor, the sensor file including a sensor type;
add a sensor entry based on the sensor file to the sensor registry; and
add the newly introduced sensor type to the list of recognized and monitored sensor types.

23. The system of claim 22 wherein the sensor management system is further configured to monitor sensors in the sensor registry.

24. The system of claim 22 wherein the sensor management system is further configured to check if the sensor type is included in a sensor registry.

25. The system of claim 22 wherein the sensor management system is further configured to:
check the syntax of the sensor file; and
return an error if the syntax is not correct.
